(19) United States
(12) Patent Application Publication
(10) Pub. No.: US 2009/0019420 A1
(43) Pub. Date: Jan. 15, 2009

(54) SOFTWARE DEVELOPMENT

(75) Inventor: Paul Johnson, Hampshire (GB)

Correspondence Address: AKERMAN SENTERFITT, P. O. BOX 3188, WEST PALM BEACH, FL, 33402-3188, US

(73) Assignee: INTERNATIONAL BUSINESS MACHINES CORPORATION, Armonk, NY (US)

(21) Appl. No.: 12/170,196

(22) Filed: Jul. 9, 2008

(30) Foreign Application Priority Data
Jul. 10, 2007 (EP) 07112138.8

(51) Int. Cl. G06F 9/44

(52) U.S. Cl. 717/101

(57) ABSTRACT

A method of creating a software product comprises maintaining a set of deployment descriptors for the product, and operating a lifecycle for the product. The lifecycle comprises the phases of developing the product, testing the product, and deploying the product. At least one phase of the lifecycle of the product includes amending the contents of the set of deployment descriptors, and at least one phase of the lifecycle of the product includes adapting the execution of the respective lifecycle phase according to the contents of the set of deployment descriptors.

### CROSS-REFERENCE TO RELATED APPLICATION

This application claims the benefit of EP Patent Application No. 07112138.8, filed on Jul. 10, 2007, which is incorporated by reference herein in its entirety.

### FIELD OF THE INVENTION

This invention relates to a method of, and a system for, creating a software product. The invention enables the intelligent deployment and autonomic management of business applications.

### BACKGROUND

The complexity of modern business systems has resulted in the creation of very complicated software products. For example, any system that involves financial transactions, such as the withdrawal of money from an ATM (Automatic Teller Machine) or the use of a website to purchase goods, requires a very sophisticated and robust software product to manage the transaction without error. It is now common for software systems to be widely distributed across different types of hardware, and across different locations, frequently spread around the World. Client devices, servers and databases must communicate quickly and accurately and the recording and processing of actions and requests must be robust and secure.

The complexity of the end product, the software application, has resulted in a corresponding increase in the complexity of the process of creation of the desired software product. It is now common for large teams of software engineers (also referred to as designers, developers and programmers) to be used to create a single software product such as a banking or website application. Business analysts and IT architects also contribute to this process, defining the capabilities of the product and decomposition into software assets.

It is also the case that because of the requirements of the end system, in respect of security and robustness, for example, a large and rigorous process of testing is needed so as to ensure that the final software product is fit for the task for which it is designed. Since a wide range of people and processes are used in the method of developing, testing and deploying a software product, there exists the need to manage effectively the process of taking the software product from creation to deployment.

At the present time, management metadata is typically collected in diverse databases and reports (if at all) which is manually accessed for deployment of resources into runtimes. Certain key information is usually required at all stages of the specification, development, deployment and management of such resources. This can be labour intensive and error prone. Metadata about the software product, such as the ultimate deployment characteristics of the product, is maintained only on an ad-hoc basis, and is neither stored centrally, nor made available to all those who need access to the information.

### SUMMARY

It is therefore an object of the invention to improve upon the known art.

According to a first aspect of the present invention, there is provided a method of creating a software product comprising maintaining a set of deployment descriptors for the product, operating a lifecycle for the product comprising the phases of developing the product, testing the product, and deploying the product, wherein at least one phase of the lifecycle of the product includes amending the contents of the set of deployment descriptors, and at least one phase of the lifecycle of the product includes adapting the execution of the respective lifecycle phase according to the contents of the set of deployment descriptors.

According to a second aspect of the present invention, there is provided a system for creating a software product comprising a database maintaining a set of deployment descriptors for the product, one or more development environments operating a lifecycle for the product, the or more deployment environments can be arranged to execute the phases of developing the product, testing the product, and deploying the product, wherein at least one phase of the lifecycle of the product includes amending the contents of the set of deployment descriptors, and at least one phase of the lifecycle of the product includes adapting the execution of the respective lifecycle phase according to the contents of the set of deployment descriptors.

Owing to the invention, it is possible to provide intelligent deployment and autonomic management of business applications. The set of deployment descriptors for the software product provides a central repository for deployment data relating to the software product that is being created. As the software product passes through the lifecycle phases of development, testing and deployment, the elements within the set of deployment descriptors are added to, enhanced and exploited by the relevant engineer(s) in the respective phase. In this way, the management of the creation process is greatly enhanced, and the engineers at each phase of the creation have access to information that will assist the ultimate deployment of the software product.

Enterprise Java Beans introduced the concept of a deployment descriptor, which is packaged with the source code to identify parameterized values and resource bindings. This invention builds on this notion by proposing extension of that concept to classical program languages, and that other key data can be added to the deployment descriptor, which enables intelligent development, deployment and autonomic management. The data would be contributed to and exploited by all engineers and applications surrounding the software product lifecycle. This information would be optional in the descriptor, allowing staged introduction on tooling exploitation. It is also proposed that the deployment descriptor could also contain a reference to an external file, to support the integration of third party data.

This approach can be utilized for general deployment of an application into any server environment. Typical key data that would be embodied in elements of deployment descriptors and exploited by this approach, for example when used in a CICS environment, would be as follows:

| | |
|---|---|
| <MemberOfApplication> | Membership of an application |
| <PerformanceMetrics> | Such as CPU, Storage etc |
| <Affinity> | Data affinities (the need to bind the application |
| | to a given server for some amount of time |
| | in a dynamically balanced environment) |
| <ExecutionEnvironment> | Facilities used by this code, for example |
| | Web services; TCP/IP; SNA; |
| | dynamically workload managed. |

The base resources that the IT shops manipulate consist of server configuration resources, resources that applications use (such as files) and the application assets themselves. In CICS terms this would be transaction, program, TDqueues, TSqueues, and so on. In respect of Business Applications, these are the applications such as banking, payroll, ledger, etc.

ApplicationName IS {transactions, programs, in server regions}

ApplicationName REFS {Files, TDQueues, TSQueues, . . . in server regions}

ApplicationName REQUIRES {Environmental specifics e.g. TCPIP, VSAM . . . }

These are general relations; that is, an asset can be the member of more that one relation. For example, a common services print program can be in multiple applications. The application is also the same, although the physical deployment into an environment may be different (consider a local program versus a remote program). These relationships therefore identify the applications, and there physical binding to a given environment. This is consistent to the notion of server configuration (related to Environmental specifics), resource binding (the placement of the resources referenced by the applications; e.g., files), and the application assets themselves.

Preferably, the execution of a phase of the lifecycle of the product includes operating a management tool on the software product, the management tool accessing the deployment descriptors during execution. The utilization by AD (Application Development) tooling, change and configuration management tools would be multifold. For example, the descriptors would be used as a declaration of the contract for the development of that piece of software. Utilized by the AD Interactive Development Environment (IDE) to ensure the contract was not broken (e.g., utilizing a command that would create affinity in a dynamic environment). Code assist would be possible with this knowledge.

The descriptors could also be used as a measure of the completed code (“this now uses web services”), to identify characteristics of the test environment required for unit test (whether preconfigured, or as a way of configuring that environment), and to identify which applications are affected by the change (e.g., a shared program between several business applications) and testing scenarios.

Other uses would include use by performance analysis products to determine and contribute to/refine the performance metrics for Business Application profiling, and by deployment tools to enable intelligent deployment of assets into QA and production systems where expected volumes may be known. “I want to deploy this here;” “Where can I deploy this.” Not only can the resource binding be ascertained, but also physical capacity, and environment matching.

Equally, the descriptors could be used by deployment when moving Business Applications across systems. The set of descriptors for all deployed applications in a given system define the required environmental characteristics of that system, therefore facilitating subsystem migration testing (as part of product migration), by Best Practice tooling (applying knowledge of the combined set of resources to the realtime capabilities of the runtime), by automation tools as part of deployment to automatically generate performance thresholds (done manually today) which can be deployed in the target environment by simple selection, thus reducing effort, error and highlighting key metrics for monitoring by reduced skill levels of staff, and by System Management products to combine that data and runtime state to provide impact analysis when planned/unplanned state change/outages occur. Utilizing the <MemberOfApplication> descriptor element would enable Business Application management to be provided.

The methodology advantageously further comprises repeating the lifecycle, wherein at least one phase of the repeated lifecycle of said product includes adapting the execution of the respective lifecycle phase according to the contents of the deployment descriptors. At least one phase of the repeated lifecycle of the product includes amending the contents of one of the deployment descriptors. The development, testing and deployment lifecycle will be repeated for many products, for example when a new feature is added to the business process which the product is embodying. In the example, of the ATM software product, then it may be desired to add a new function to an ATM, so that it is possible to top-up the credit on a mobile phone. This will require the software product to go through a new lifecycle. The invention is even more advantageous in this circumstance, as amendments (whether additions or enhancements) to the deployment descriptors made at the later testing and deployment phases will now be available at the second development phase. This will allow the software engineers who are executing the additional feature(s) of the software product to have access to the metadata embodied in the deployment descriptor that was created by the testers and deployment engineers, and this will be used to adapt their development phase.

### BRIEF DESCRIPTION OF THE DRAWINGS

Embodiments of the present invention will now be described, by way of example only, with reference to the accompanying drawings, in which:

FIG. 1 is a schematic diagram of a system for creating a software product,

FIG. 2 is a schematic diagram showing in more detail the creation of metadata during creation of the software product,

FIG. 3 is a flow diagram of a method for creating the software product, and

FIGS. 4 to 6 are schematic diagrams of respective phases of the process for creating the software product.

### DETAILED DESCRIPTION

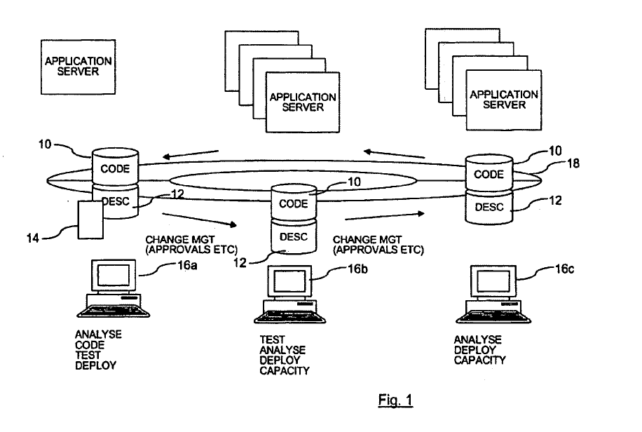

FIG. 1 shows schematically the systematic creation of a software product, as represented by source code databases 10. The system for creating the software product also comprises databases 12 maintaining the set of deployment descriptors 14 for the software product. Associated with each piece of source code is an enhanced deployment descriptor 14. The system also includes development environments 16 operating a lifecycle 18 for the product. Each environment 16 is arranged to execute the phases of the lifecycle 18, the phases comprising developing the product (at environment 16a), testing the product (16b), and deploying the product (16c). Other stakeholders that participate in this lifecycle are not shown such as the Business Analyst specification of the business goals for the product, and IT Architects decomposition of those requirements into associated IT assets, but are simply incorporated into this lifecycle as required. The lifecycle 18 of the software product is managed by teams of software engineers, who contribute at each stage according to the requirements of the end business application.

At the initial development stage, analysis of the desired solution is undertaken, followed by the generation of suitable source code that will comprise the software product. Initial testing of the source code is carried out as a unit, to ensure that no defects occur internally within the source code. Once the source code is considered sufficiently robust, then the code is deployed in a test environment. The test environment is designed to mimic as much as possible the end situation and the activity that is likely to take place in that environment. Analysis takes place upon the performance of the software product. The typical resource utilization is also determined via performance measurement tools, which will allow deployment to then be based not only on resource binding attributes, but in conjunction with expected volumes, be used to predict the required capacity of the target systems. Once the testing is completed, then the software product moves to the deployment phase and is deployed into production.

During the creation of the software product at least one phase of the lifecycle 18 of the product includes amending the contents of the deployment descriptor 14, and at least one phase of the lifecycle 18 of the product includes adapting the execution of the respective lifecycle phase according to the contents of the deployment descriptors. In general, the elements of the deployment descriptors 14 will be amended during each and all phases of the development testing and deployment of the software product. In each phase, details about the software product are embodied in the set of deployment descriptors 14. The elements of the descriptors may be self-contained pieces of information (metadata) about the product, or they may be references to external documents of files that contain further information and are located externally of the database 12 that is maintaining the set of descriptors 14.

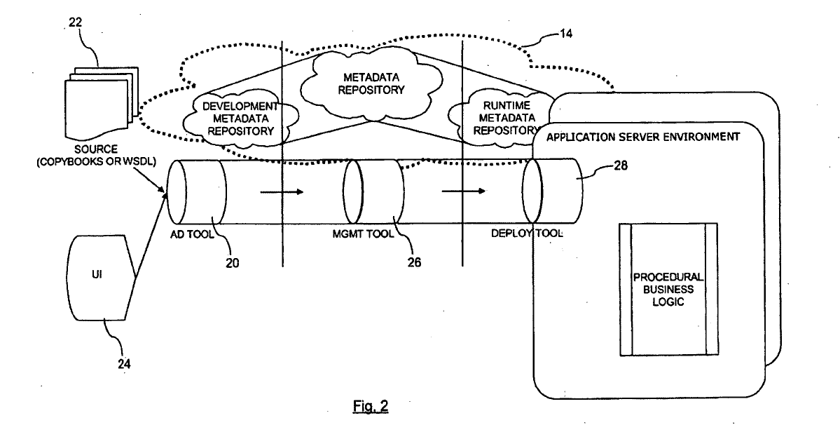

FIG. 2 shows how metadata is created as the software product is created. At the initial stage 20, application development tools such as IDEs which provide a modern User Interface (UI) 24, are used by the software developers to create source code 22 for a software product. During this development phase, data such as performance metrics and the necessary execution environment can be stored by the developers in the deployment descriptor 14, which stores information for the software product that is being created

At the second stage 26, the testing of the product is carried out using management tools, and the set of descriptors 14 can be used as a data source, either directly by the tools being used or indirectly by the engineers using the tools, to adapt the testing process. New metadata may be created at this phase, and this can be included in the deployment descriptor 14. Descriptor elements already present within the deployment descriptor 14 can be changed or enhanced at this stage according to the changing structure of the software product. The software product may be adapted in the testing phase in response to the results of the testing.

Following the testing of the software product, deployment of the product takes place at the third stage 28. Here, again, the data stored in the deployment descriptors 14 can be used to adapt the process of deployment of the software product. For example, a descriptor may relate to the execution environment and may mandate that a specific version of software component is needed in the execution environment. This can be accessed by the engineers carrying out the deployment and used to make selections about the specific actions that they take. At the same time, they may become aware that limits on the performance of the software product or expected resource utilization for this specific environment can again be added to the deployment descriptor 14 as new descriptor elements. For example, the specifics of hardware at the deployment end of the chain may determine that a maximum message rate (of, say, 10 000 a second) is not to be exceeded by the product. This performance metric can then be encoded in a descriptor element and stored within the descriptor 14.

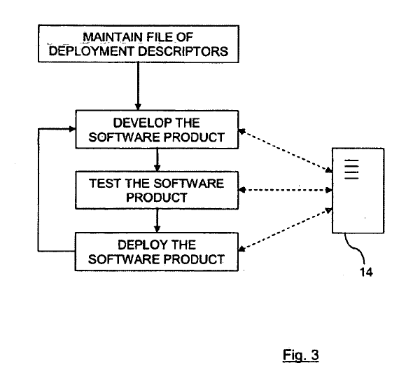

FIG. 3 summarizes the global method that is used to create the software product. The process begins within the maintaining of the set of deployment descriptors 14 for the product and continues with the operation of the lifecycle 18 for the product. The lifecycle 18 comprises the phases of developing the product, testing the product, and deploying the product. At least one phase of the lifecycle of the product includes amending the contents of the deployment descriptors, and at least one phase of the lifecycle of the product includes adapting the execution of the respective lifecycle phase according to the contents of the deployment descriptors. In general in all phases will data be written to the deployment descriptor 14 (as new or amended elements), and in all phases will that data be consulted to determine if any adaptation of the phase of the lifecycle 18 is needed.

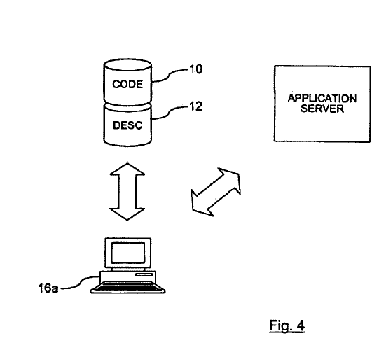

FIG. 4 shows schematically the first phase of the lifecycle of the software product, in more detail. A suitable integrated development environment 16a is used to generate source code that is stored in the database 10. During this phase source code creation and basic unit testing occurs, and the deployment descriptor 14 stored by the database 12 is expanded with deployment descriptors generated during the development phase.

The developer selects the appropriate design template provided by the IDE, and by utilizing the environmental information in the deployment descriptor 14 provides appropriate code creation assist facilities, ensuring that the contract for the application is not violated. From the application membership relation, it identifies which applications must be tested as a result of the code change. The deployment descriptor metadata can also be used to dynamically configure the appropriate server runtime in which to test the code change. Test case recording may also be performed as part of the unit testing of the change. Finally the set of changes can be packaged together and submitted through a change and release management process.

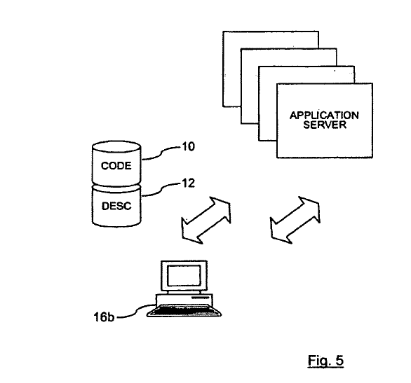

The second phase of the process of creating the software product is shown in FIG. 5, where testing of the software product in operation takes place, as a quality assurance deployment. Here, the set of deployment descriptors 14, maintained by the database 12, is accessed and the contents of the deployment descriptors 14 are used by the testing engineers to adapt the testing process. Specific descriptors created by the engineers in the first phase are used to guide and direct the testing process. As this testing takes place further descriptor elements may be generated or pre-existing ones may be adapted or enhanced according to the nature of the testing results. As previously described, key performance metrics can be measured via performance analysis tools to update these metrics in the deployment descriptor. The use of the descriptors 14 enables the ability to intelligently deploy the application.

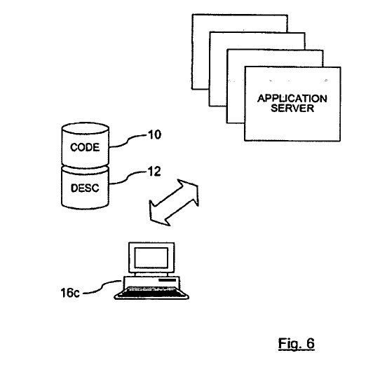

The final phase in the lifecycle is shown in FIG. 6, which illustrates the process of production deployment of the software product. Once again, the set of deployment descriptor 14, which is maintained by the database 12, is accessed and the contents of the set of deployment descriptors 14 are used by the deployment engineers to adjust the deployment of the product. The descriptors created and amended/enhanced by the developers and testing engineers in the first and second phases are used to steer the deployment process. While this deployment is executed, further descriptor elements may be generated or pre-existing ones may be amended in line with the deployment. When the lifecycle is repeated, for example, to add a further feature to the software product, then the deployment descriptors created during the deployment phase of the lifecycle will be available in the first phase of the second pass through the lifecycle. The software developers in the first phase have the advantage of the feedback embodied by the deployment descriptors in the final phase of the previous lifecycle.

When deploying into the production application server environment, the deployment descriptor information such as performance metrics and environment can be used to automatically generate threshold detection criteria (which is manually performed today), which the deployer can optionally deploy into the production runtime management software.

A simple example of this would be the measured storage utilization of the application. A threshold could be created which alerts the system programmer or operator when the application consumes more than this amount, or to request the automation software to take more immediate action such as cancel the task, disable the application and notify the operator of the situation. Affinity metrics would enable the runtime to manage the affinity to a given server region, today managed by manual definition to the server runtime. Binding of the application to the appropriate execution environment is possible by exploiting the descriptor data and matching it to the actual server configuration.

1. A method of creating a software product, the method comprising:
maintaining a set of deployment descriptors for said product; and
operating a lifecycle for said product comprising the phases of
developing said product,
testing said product, and
deploying said product;
wherein at least one phase of the lifecycle of said product includes amending the contents of the set of deployment descriptors;
wherein at least one phase of the lifecycle of said product includes adapting the execution of the respective lifecycle phase according to the contents of the set of deployment descriptors.

2. The method of claim 1, further comprising repeating said lifecycle, wherein at least one phase of the repeated lifecycle of said product includes adapting the execution of the respective lifecycle phase according to the contents of the set of deployment descriptors.

3. The method of claim 2, wherein at least one phase of said repeated lifecycle of said product includes amending the contents of the set of deployment descriptors.

4. The method of claim 1, wherein execution of a phase of said lifecycle of said product includes operating a management tool on said software product, said management tool accessing said set of deployment descriptors during execution.

5. The method of claim 1, wherein a deployment descriptor element of said set of deployment descriptors comprises a reference to an external file

6. The method of claim 1, wherein a deployment descriptor element of said set of deployment descriptors comprises a performance metric.

7. The method of claim 1, wherein a deployment descriptor element of said set of deployment descriptors comprises data on an execution environment.

8. A system for creating a software product, the system comprising
a database maintaining a set of deployment descriptors for said product; and
one or more development environments operating a lifecycle for said product, the one or more development environments arranged to execute the phases of
developing said product,
testing said product, and
deploying said product;
wherein at least one phase of the lifecycle of said product includes amending the contents of the set of deployment descriptors, and
at least one phase of the lifecycle of said product includes adapting the execution of the respective lifecycle phase according to the contents of the set of deployment descriptors.

9. The system of claim 8, wherein said system is arranged to repeat said lifecycle, and at least one phase of the repeated lifecycle of said product includes adapting the execution of the respective lifecycle phase according to the contents of the set of deployment descriptors.

10. The system of claim 9, wherein at least one phase of said repeated lifecycle of said product includes amending the contents of the set of deployment descriptors.

11. The system of claim 8, wherein execution of a phase of said lifecycle of said product includes operating a management tool on said software product, said management tool accessing said set of deployment descriptors during execution.

12. The system of claim 8, wherein a deployment descriptor element of said set of deployment descriptors comprises a reference to an external file.

13. The system of claim 8, wherein a deployment descriptor element of said set of deployment descriptors comprises a performance metric.

14. The system of claim 8, wherein a deployment descriptor element of said set of deployment descriptors comprises data on an execution environment.
